(19) United States
(12) Patent Application Publication
(10) Pub. No.: US 2012/0036402 A1
(43) Pub. Date: Feb. 9, 2012

(54) User-customizable error forwarding method and system

(76) Inventor: Peter DeLuca, Syosset, NY (US)

(21) Appl. No.: 12/806,222

(22) Filed: Aug. 9, 2010

(51) Int. Cl. G06F 11/07

(52) U.S. Cl. 714/57; 714/E11.025

(57) ABSTRACT

A user-customizable error forwarding method and system are described for accomplishing user-customizable error forwarding. The method includes providing an error forwarding option on an error message. Upon selection of the error forwarding option by the user, an e-mail is automatically generated with the message portion of the e-mail automatically populated with information relating to the error. The user can then customize the automatically generated e-mail by inputting the address of a recipient to receive the e-mail and/or adding text to the message portion of the e-mail. The system for user-customizable error forwarding includes: a display for showing the user an error message along with an error forwarding option; software for automatically generating an e-mail that is populated with information relating to the error upon selection of the error forwarding option by the user; input means for allowing the user to input the address of a recipient to receive the automatically generated e-mail and/or for adding text to the message portion of the e-mail; and software to allow the sending of the automatically generated, customized e-mail.

### BACKGROUND

Users of computers who have limited computer science or information technology (“IT”) training can find error messages quite distressing or annoying. Frequently, error messages are technical in nature and may not be easily understood by the user. Additionally, prior art error reporting messages (see FIG. 1) do not allow the user to choose to whom the error is reported or to add information to the error report. Computers have been around for many years with millions (perhaps billions) of dollars being spent on software development. Many developed software often “crash” and produce error messages which are generally meaningless to a non-IT trained or typical computer user. Many error messages tend to repeat themselves if the same software is run or executed by the user. However, the user often opts to ignore such error messages due to the anticipated time wasted to figure them out and/or to contact an IT person via a phone.

It would be advantageous if a user could simply forward such error messages via e-mail to a person of the user's choosing, such as, for example, an IT support person or office manager. It would also be advantageous if the user could add information to the message, such as, for example a description of the circumstances under which the error message was generated.

### SUMMARY

The present disclosure relates to a user-customizable error forwarding method as well as a system for accomplishing user-customizable error forwarding. In embodiments, the method includes providing an error forwarding option on an error message. Upon selection of the error forwarding option by the user, an e-mail is automatically generated with the message portion of the e-mail automatically populated with information relating to the error. The user can then customize the automatically generated e-mail by inputting the address of a recipient to receive the e-mail and/or adding text to the message portion of the e-mail.

In embodiments the system for user-customizable error forwarding includes: a display for showing the user an error message along with an error forwarding option; software for automatically generating an e-mail that is populated with information relating to the error upon selection of the error forwarding option by the user; input means for allowing the user to input the address of a recipient to receive the automatically generated e-mail and/or for adding text to the message portion of the e-mail; and software to allow the sending of the automatically generated, customized e-mail.

### BRIEF DESCRIPTION OF THE DRAWINGS

FIG. 1 shows a prior art error reporting screen shot.

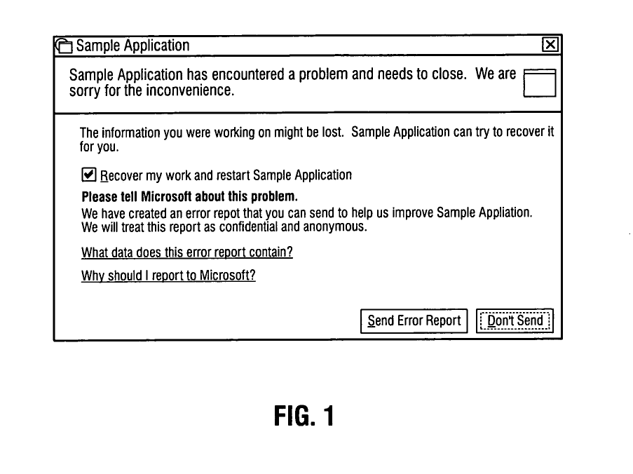

FIG. 2 is a flow chart showing an illustrative embodiment of a user-customizable error forwarding method in accordance with this disclosure.

FIG. 3 is a screen shot showing an error message including an error forwarding option in accordance with an embodiment of this disclosure.

FIG. 4 is a screen shot showing an automatically generated e-mail in accordance with an embodiment of this disclosure having the message portion thereof populated with information relating to the error message shown in FIG. 3.

FIG. 5 is a screen shot showing the automatically generated e-mail of FIG. 4 that has been user-customized by adding an e-mail recipient of the user's choosing.

FIG. 6 is a screen shot showing the automatically generated e-mail of FIG. 4 that has been user-customized by adding text to the message portion thereof.

FIG. 7 shows an illustrative embodiment of a system for user-customizable error forwarding in accordance with this disclosure.

### DETAILED DESCRIPTION

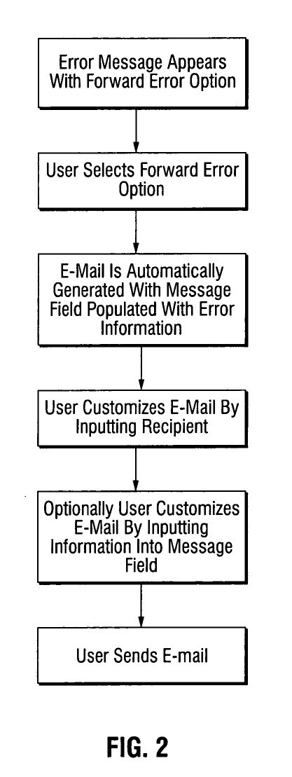

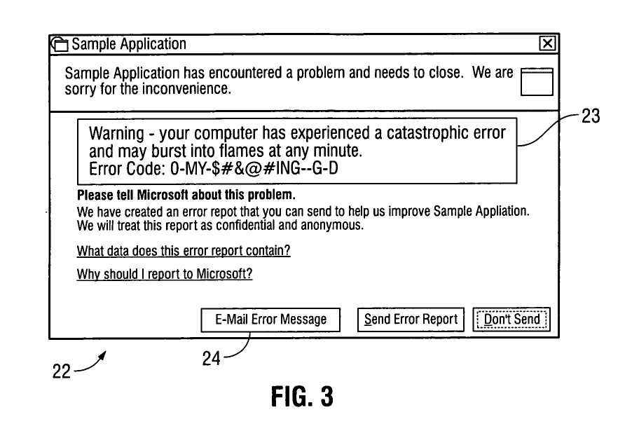

An illustrative embodiment of a user-customizable error forwarding method in accordance with this disclosure is shown in the flow chart presented as FIG. 2. As seen in FIG. 2, when an error occurs in an operating system or other program, an error message 22 is generated and shown on a display (such as a monitor or touch screen display) that includes a description 23 of the nature of the error an error forwarding option. In embodiments, the error forwarding option may appear as button 24 labeled “E-Mail Error Message” on the error message itself as shown in FIG. 3. In other embodiments, the error forwarding option may appear as a window separate from the error message, with the separate window displaying an inquiry such as “Do you wish to forward this error message?” and being provided with “Yes” and “No” buttons. Other ways of presenting the user with an error forwarding option will be readily apparent to one skilled in the art reading this description.

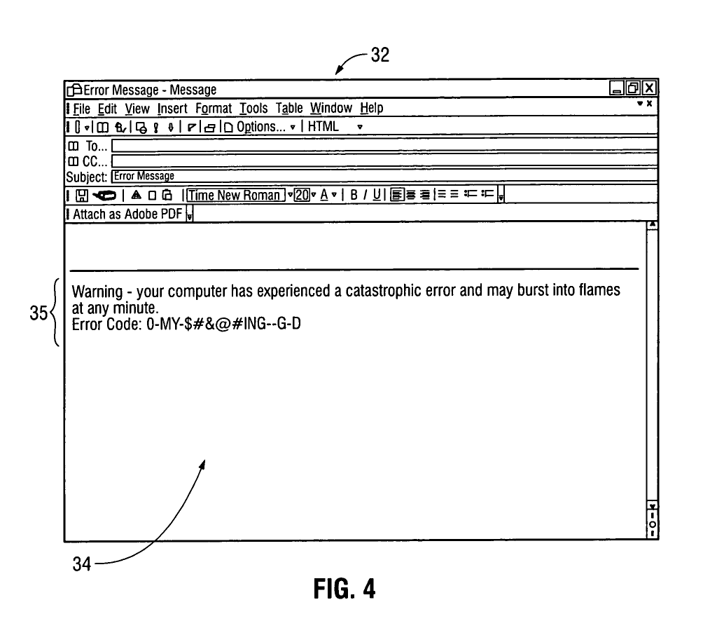

The user then selects the error forwarding option. Upon selection of the error forwarding option by the user, an e-mail 32 is automatically generated with the message portion 34 of an e-mail populated with information relating to the error as shown in FIG. 4. The information relating to the error may be a textual description 35 of the error, a graphical image of the error message, or simply an error code. Other ways of presenting information relating to the error in the message portion of the e-mail will be readily apparent to one skilled in the art reading this description. Additionally, while the present description is presented in terms of an e-mail, it should be understood that those skilled in the art reading this description will envision other types of messages may be generated. For example, in embodiments, instead of an e-mail, a text message may be generated.

This e-mail is customizable by the user. By the term “customizable” it is meant that the user can manipulate and/or alter the e-mail before sending the e-mail.

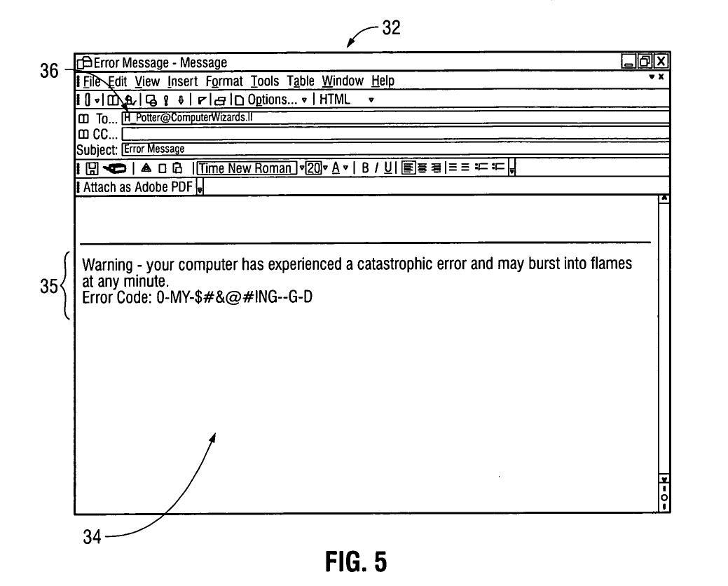

For example, in embodiments, the user may customize the e-mail by inputting the e-mail address of any desired recipient to receive the e-mail into the “To:” field 36 of e-mail 32 as shown in FIG. 5. A user may, for example, choose to send the message to a friend who has some computer science or IT training. Alternatively, if the error occurs at work in an office setting, the user may choose to send the message to an office manager who can then contact the appropriate IT person. It is also envisioned that the user may choose to send the message directly to appropriate person having IT training. It is further envisioned that in embodiments the recipient may be pre-designated by the user, such that the network address or e-mail address of the pre-designated recipient automatically populates the “To:” field 36 when an error occurs.

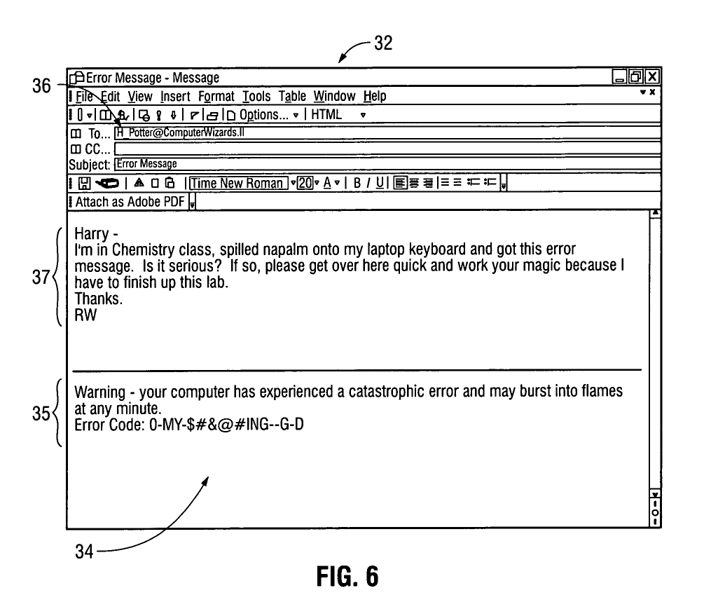

In embodiments, the user may also customize the e-mail by inputting information into the message portion of the e-mail. As shown in FIG. 6, for example, the user may add text 37 to the message portion of the e-mail explaining the circumstances under which the error message was generated. As another example, in embodiments, the user may customize the e-mail by inputting information into the message portion of the e-mail designating where the user is so that IT personnel can be sent to remedy the error. This may be particularly important when the error is generated on a portable laptop computer. As another example, in embodiments, the user may customize the e-mail by inputting information into the message portion of the e-mail indicating the urgency with which the error needs to be addressed. As another example, in embodiments, the user may customize the e-mail by inputting information into the message portion of the e-mail simply requesting a return message indicating how the error should be addressed. Other ways of in which the user may customize the e-mail will be readily apparent to one skilled in the art reading this description.

Once the e-mail is customized by the user, the e-mail may be sent to the recipient, thereby forwarding the error message to a recipient of the user's choosing and providing any supplemental information deemed relevant by the user. It is envisioned that the recipient can send an e-mail back to the user if additional information is needed by replying to the e-mail sent by the user to the recipient. Alternatively, it is envisioned that the recipient can be pre-authorized by the user to forward the e-mail to another individual who may be more familiar with the error message.

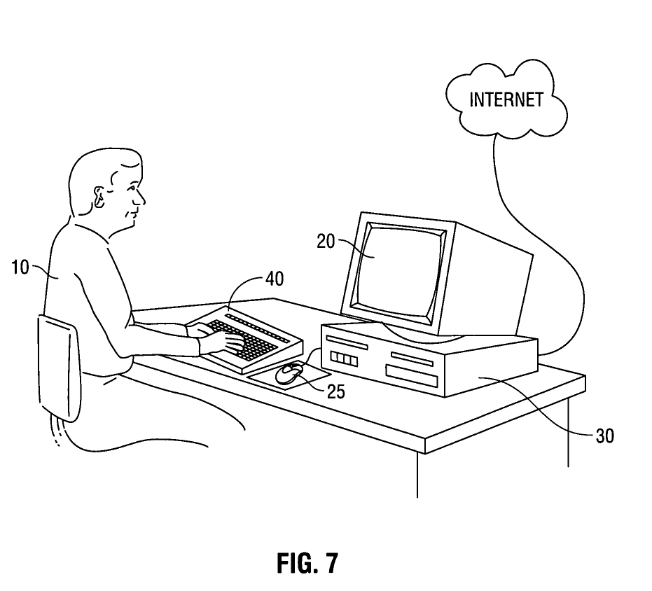

FIG. 7 shows a system for user-customizable error forwarding in accordance with embodiments of the present disclosure. The system includes a display 20 for showing the user 10 an error message along with an error forwarding option generated by a processor 30 attached to display 20. The user may select the option of forwarding the error message using mouse 25 or hitting the “enter” key on keyboard 40. Software for automatically generating an e-mail that is automatically populated with information relating to the error upon selection of the error forwarding option by user 10 is installed on processor 30. The system further includes input means, such as, for example, keyboard 40, for allowing user 10 to input an e-mail address of a recipient for the automatically generated e-mail and/or for adding text to the message portion of the e-mail. In embodiments, the input means may be incorporated into the display as a touch screen. Software installed on processor 30 allows sending of the automatically generated e-mail after it has been customized by the user. The e-mail may be sent over the internet as shown in FIG. 7, and/or one or more additional networks, such as a local area network or VoIP network.

The writing of software providing the functions and applications described herein is well within the purview of one skilled in the art reading this description.

While an embodiment of the present system is shown in FIG. 7 as being a desktop work station, other suitable hardware that includes a processor, display, input means and which can be loaded with the software providing the functions described herein will be readily apparent to one skilled in the art reading this description. In embodiments, for example, the system is a, or embedded within a portable computing device such as, for example, a laptop or a netbook, which includes a processor, display, input means and the described software. As another example, in embodiments, for example, the system is a, or embedded within a telephonic device, such as, for example a PDA, a cell phone or a smart phone, such as, a Blackberry®, which includes a processor, display, input means and the described software.

In view of the many possible embodiments to which the principles of this disclosure may be applied, it should be recognized that the embodiments described herein with respect to the drawing figures is meant to be illustrative only and should not be taken as limiting the scope of the invention. For example, those of skill in the art will recognize that the elements of the illustrated embodiments shown in software may be implemented in hardware, firmware and combinations thereof or that the illustrated embodiments can be modified in arrangement and detail without departing from the spirit of the invention. Therefore, the invention as described herein contemplates all such embodiments as may come within the scope of the following claims and equivalents thereof.

1. A user-customizable method of forwarding an error message comprising:
providing an error forwarding option on an error message;
upon selection of the error forwarding option by the user, automatically generating a message populated with information relating to the error; and
allowing the user to customize the automatically generated message before the message is sent.

2. A user-customizable method of forwarding an error message as in claim 1 wherein automatically generating a message comprises generating an e-mail.

3. A user-customizable method of forwarding an error message as in claim 1 wherein automatically generating a message comprises generating a text message.

4. A user-customizable method of forwarding an error message as in claim 1 wherein allowing the user to customize the automatically generated message comprises allowing the user to input a network address for a recipient.

5. A user-customizable method of forwarding an error message as in claim 1 wherein allowing the user to customize the automatically generated message comprises allowing the user to input information relating to creation of the error message.

6. A system for user-customizable forwarding of an error message comprising:
a display for showing a user an error message along with an error forwarding option;
software for automatically generating a message that is automatically populated with information relating to the error upon selection of the error forwarding option by the user;
input means for allowing the user to customize the message; and
software to allow the sending of the automatically generated, customized e-mail.

7. A system for user-customizable forwarding of an error message as in claim 6 wherein the input means is a keyboard.

8. A system for user-customizable forwarding of an error message as in claim 6 wherein the display is a touch screen display.

9. A system for user-customizable forwarding of an error message as in claim 6 wherein the software for automatically generating a message that is automatically populated with information relating to the error upon selection of the error forwarding option by the user generates an e-mail.

10. A system for user-customizable forwarding of an error message comprising:
means for a showing a user an error message along with an error forwarding option;
means for automatically generating a message that is automatically populated with information relating to the error upon selection of the error forwarding option by the user;
input means for allowing the user to customize the message; and
means for sending the automatically generated, customized e-mail.

11. A system for user-customizable forwarding of an error message as in claim 10 wherein the input means is at least one of a keyboard and a touch screen display.

12. A system for user-customizable forwarding of an error message as in claim 6 wherein the software for automatically generating a message that is automatically populated with information relating to the error upon selection of the error forwarding option by the user generates an e-mail.

13. A system for user-customizable forwarding of an error message as in claim 10 wherein the means for showing is a touch screen display.

14. A system for user-customizable forwarding of an error message as in claim 10 wherein the system is embedded in a smart phone.

15. A system for user-customizable forwarding of an error message as in claim 10 wherein the system is embedded in a portable computing device.
